(19) United States
(12) Patent Application Publication
(10) Pub. No.: US 2019/0275701 A1
(43) Pub. Date: Sep. 12, 2019

(54) PROCESS FOR CUTTING SLICES FROM AN INGOT MADE OF HARD MATERIAL AND ABRASIVE WIRE

(71) Applicants: THERMOCOMPACT, Metz Tessy (FR); COMMISSARIAT A L'ENERGIE ATOMIQUE ET AUX ENERGIES AL TERNATIVES, Paris (FR)

(72) Inventors: Michel LY, Annecy (FR); Ludovic LAFLEUR, Talloires (FR); Tifenn DECORPS, Villaz (FR); Xavier WEBER, Annecy (FR)

(73) Assignees: THERMOCOMPACT, Metz Tessy (DE); COMMISSARIAT A L'ENERGIE ATOMIQUE ET AUX ENERGIES AL TERNATIVES, Paris (FR)

(21) Appl. No.: 16/335,324

(22) PCT Filed: Sep. 19, 2017
(86) PCT No.: PCT/FR2017/052495

§ 371 Date: Mar. 21, 2019

(30) Foreign Application Priority Data
Sep. 26, 2016 (FR) 1659009

(51) Int. Cl. B28D 5/04

(52) U.S. Cl. CPC B28D 5/045; B28D 5/0064

(57) ABSTRACT

A marked abrasive wire including, on the cylindrical outer face thereof and between abrasive particles, a mark that is deformed as a function of the twisting of the abrasive wire, this mark extending longitudinally over at least 50% of the total length of the abrasive wire and having a reflectance Rm at a wavelength λm,—during the displacement of the wire and with the aid of a sensor sensitive to the reflectance of the outer face of the abrasive wire, the reading of at least one characteristic of the current shape of the mark that varies as a function of the twisting of the abrasive wire, and—the estimation of the twisting of the abrasive wire from the observed characteristic of the current shape of the mark and from a known value of this characteristic corresponding to a known twisting of the abrasive wire.

The invention relates to a method for cutting slices from an ingot made of hard material. Another subject is an abrasive wire, a reel of abrasive wire and a cutting machine for implementing this cutting method.

In this description, a material is considered to be hard if its microhardness on the Vickers scale is greater than 400 Hv or greater than or equal to 4 on the Mohs scale. In the case of the ingot, the Vickers microhardnesses are expressed for a load of 110 grams force, that is to say for a force of 0.49 N. For the other elements, the person skilled in the art knows that the load must be adjusted as a function of the thickness of the material on which the measurements are performed so that the size of the Vickers indenter is less than the thickness of the material.

Known methods comprise the displacement between two wire guides of an abrasive wire by making it rub on the ingot and thus saw this ingot, this abrasive wire comprising:
a longitudinal axis along which it extends,
a cylindrical outer face which encircles this longitudinal axis, and
abrasive particles protruding from the cylindrical outer face.

For example, such a cutting method is described in the application US 20120298091 A or WO 2011/070386 A1.

In the field of cutting slices from an ingot made of hard material, it has been observed that, during the cutting method, the twisting of the wire can change. The changes of the twisting of the abrasive wire can be provoked deliberately and/or accidentally. For example, the application DE 102011055006 A1 teaches different techniques for deliberately driving the abrasive wire in rotation about its longitudinal axis during the cutting method. In fact, turning the abrasive wire about its longitudinal axis is advantageous, for example, to uniformly distribute the wear of the abrasive wire over all its outer periphery.

However, the precise twisting applied to the abrasive wire is difficult to control because it depends on many parameters of which some are difficult to control and others are unknown. Now, an excessive twisting of the abrasive wire must be avoided because it reduces the tensile strength of this abrasive wire, which can be reflected in a premature breaking of this wire and therefore in more frequent interruptions of the cutting method. An excessive twisting typically describes a twisting greater than 10 turns/cm.

The problem is that the twisting of the wire occurs when the latter is displaced during the cutting method and that, at that moment, this twisting is very difficult to measure. Examples of measurement of the twisting of a wire are described in the following documents: JP 2012250329 A and WO 96/33836 A1.

The invention aims to remedy this drawback by proposing a cutting method during which the twisting of the abrasive wire can be easily estimated. Its subject is therefore such a cutting method in accordance with claim 1.

In the method claimed, the twisting of the abrasive wire is simple to estimate through the use of a marked abrasive wire comprising an observable mark on its outer face which is deformed as a function of the twisting of this abrasive wire. In fact, contrary to the twisting of the abrasive wire which is difficult to directly observe, the shape of the mark on the outer face of the abrasive wire is easy to observe. Now, since this shape depends on the twisting of the wire, it is possible to deduce therefrom the twisting of the abrasive wire even during its displacement to saw an ingot.

Furthermore, given that the mark is present on the outer face of the abrasive wire, it is the abrasive particles of this abrasive wire which rub on the ingot to saw it. These abrasive particles protrude on the outer face of the abrasive wire so that the outer face situated between these abrasive particles does not normally often come directly into contact with the ingot. Since the outer face of the abrasive wire between the abrasive particles does not rub or rubs little on the ingot, the mark which is located thereon wears little or not at all. It therefore remains observable for a good part of the lifespan of the abrasive wire, which makes its use possible for estimating the twisting of the abrasive wire.

The embodiments of this method can comprise one or more of the features of the dependent method claims.

These embodiments of the cutting method also offer the following advantage:
the use of measurements of the reflectance of the outer face of the abrasive wire to observe a characteristic of the shape of the mark simplifies the implementation of the method. In fact, a reflectance sensor is particularly simple to produce and to implement.
the control of a twisting device as a function of the estimated twisting makes it possible to avoid reaching an excessive twisting of the abrasive wire which substantially limits its tensile strength.

Another subject of the invention is an abrasive wire capable of being used for the implementation of the cutting method claimed.

The embodiments of this abrasive wire can comprise one or more of the features of the dependent abrasive wire claims.

These embodiments of the abrasive wire can also offer the following advantages:
the use of a mark present on the outer face only in a marked angular segment less than or equal to 180° makes it possible to observe, using a single sensor, the characteristic of the mark which depends on the twisting of the abrasive wire.
when the marked angular segment is greater than 60°, the mark is more easy to observe.
when the wavelength λₘ at which the reflectance of the outer face of the abrasive wire is measured lies between 0.5 μm and 0.7 μm, the shape of the mark can be observed even with the naked eye.
the fact that, in the absence of twisting, the mark is rectilinear or appears with a predetermined frequency in the same angular position, simplifies the estimation of the twisting of the abrasive wire.
the fact that the density of abrasive particles is greater than or equal to 10 particles/mm makes it possible to slow down the wear of the mark on the outer face of the abrasive wire.

Another subject of the invention is a roll of the claimed abrasive wire.

The claimed roll makes it possible to rotate the abrasive wire about its longitudinal axis in one direction and, alternately, in the opposite direction, without, for that, having to use a controllable abrasive wire twisting device.

Another subject of the invention is a cutting machine for the implementation of the claimed cutting method.

The invention will be better understood on reading the following description, given purely as a nonlimiting example and with reference to the drawings in which:

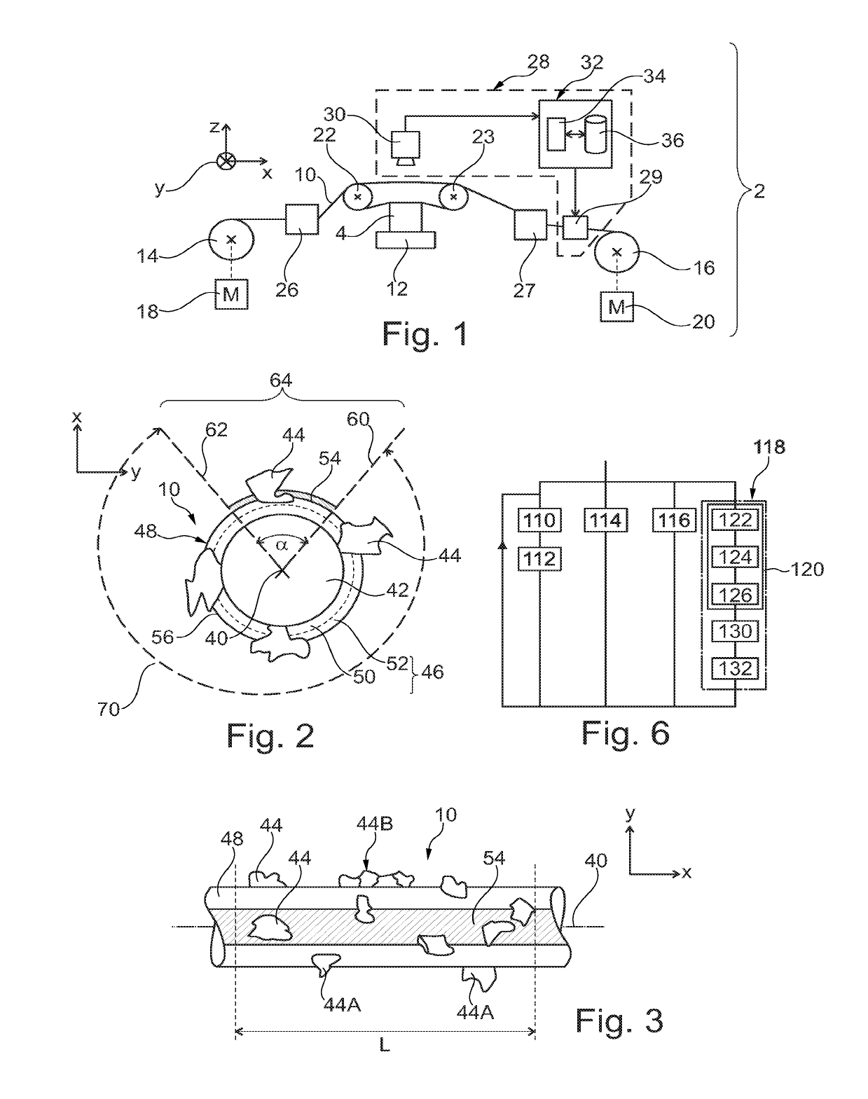

FIG. 1 is a schematic illustration of a machine for cutting slices from an ingot made of hard material;

FIG. 2 is a schematic illustration of a cross section of a first embodiment of an abrasive wire that can be used in the machine of FIG. 1;

FIG. 3 is a partial and plan view schematic illustration of a portion of the abrasive wire of FIG. 2;

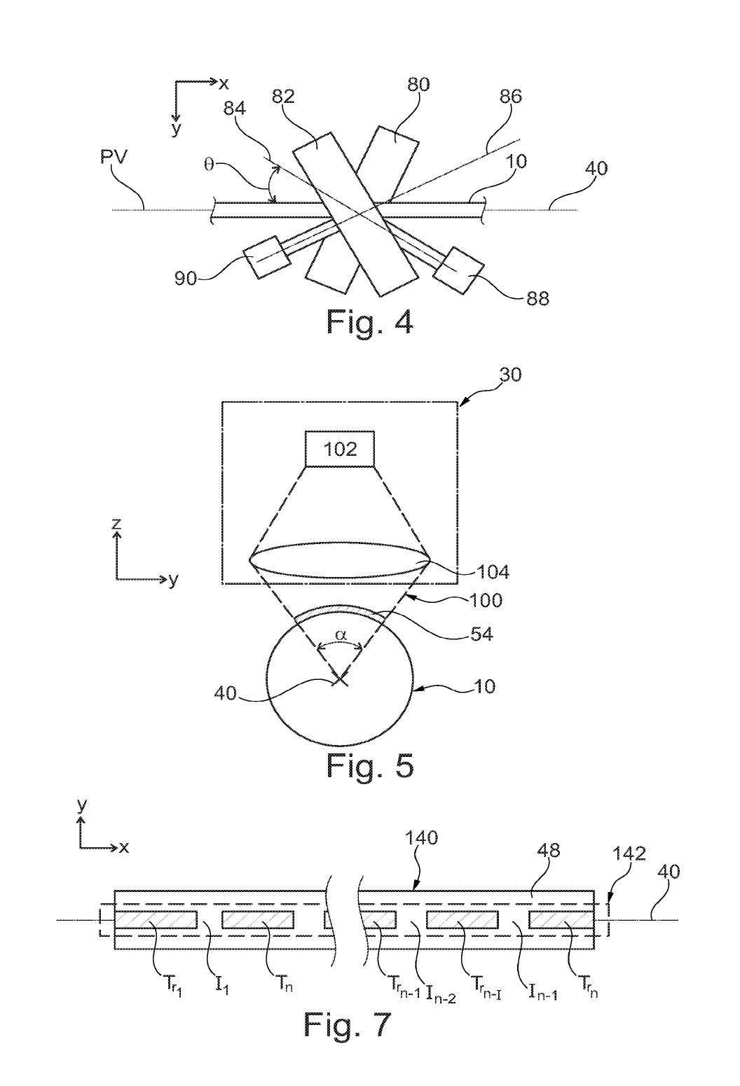

FIG. 4 is a schematic plan view illustration of a twisting device of the machine of FIG. 1;

FIG. 5 is a schematic illustration of a reflectance sensor of the machine of FIG. 1;

FIG. 6 is a flow diagram of a method for cutting slices from an ingot using the machine of FIG. 1;

FIGS. 7 and 9 are plan view schematic illustrations, respectively, of a second and a third embodiment of an abrasive wire that can be used in the machine of FIG. 1.

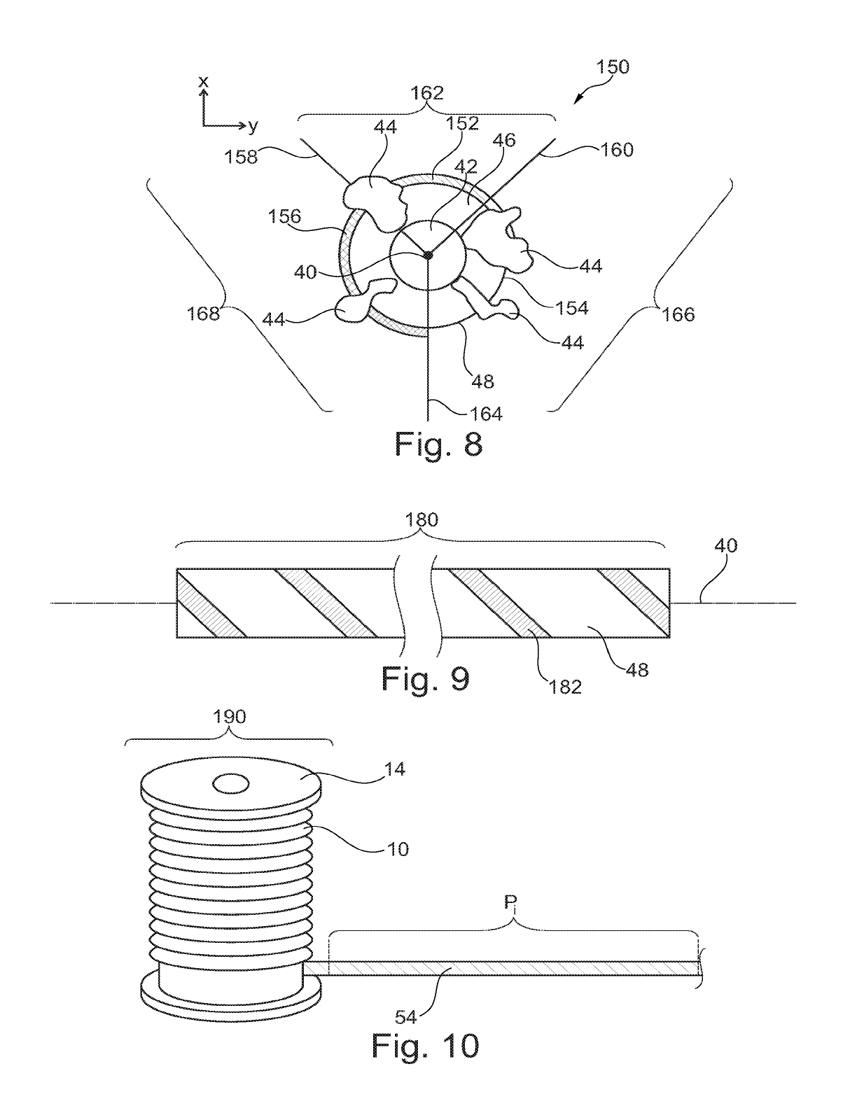

FIG. 8 is a schematic and cross-sectional illustration of a fourth embodiment of an abrasive wire that can be used in the machine of FIG. 1;

FIG. 10 is a perspective schematic illustration of a roll of abrasive wire that can be used in the machine of FIG. 1.

In these figures, the same references are used to designate the same elements. Hereinafter in this description, the features and functions well known to the person skilled in the art are not described in detail.

FIG. 1 represents a machine 2 for cutting an ingot 4 into thin slices. The ingot 4 is a block, typically parallelepipedal, of a hard material. For example, the hard material is monocrystalline or polycrystalline silicon or even sapphire or silicon carbide. Here, the ingot 4 is a block of monocrystalline silicon. This ingot 4 extends parallel to a horizontal direction Y. FIG. 1 and the following figures are oriented relative to an orthogonal reference frame XYZ, in which X and Y are horizontal directions and Z is the vertical direction.

A thin slice typically describes a slice whose thickness is less than 5 mm and, generally, less than 1 mm. These slices are better known by the term “wafer”.

The machines for cutting such slices are well known and only the details necessary to an understanding of the invention are given here. For example, for more information on such a machine, the reader can refer to the application US 20120298091.

The machine 2 comprises:
an abrasive wire 10 which rubs on a top part of the ingot 4,
an actuator 12 which vertically displaces the ingot 4 as the wire 10 cuts this ingot 4,
reels 14 and 16 on which is wound and, alternately, unwound the wire 10, and
motors 18 and 20 for rotationally driving, respectively, the reels 14 and 16.

The wire 10 is intended to cut the ingot 4 by friction or abrasion. The structure of the wire 10 is described in more detail with reference to FIGS. 2 and 3. The length of this wire 10 is generally greater than 100 m or 1000 m and, usually, less than 100 km.

In the zone of cutting of the ingot 4, the wire 10 is wound around two wire guides 22 and 23 so as to obtain several sections of the wire 10 that are parallel to one another and which rub at the same time on the ingot 4. The wire guides 22, 23 are each situated on a respective side of the ingot 4 in the direction X. The space between two successive parallel sections of the wire 10 in the direction Y then defines the thickness of the cut slice.

The motors 18 and 20 drive the reels 14 and 16 in rotation, both in one direction and in the opposite direction, such that the wire 10 is driven by a reciprocating motion. Each reel 14, 16 generally comprises several turns of the wire 10 directly stacked one on top of the other in the radial direction of this reel.

The wire 10 is mechanically tautened between the reels 14 and 16. Here, the machine 2 comprises mechanisms 26 and 27 for adjusting the tension of the wire 10. For example, these mechanisms 26 and 27 make it possible to adjust the tension of the wire 10 wound on the reels 14 and 16. These mechanisms 26 and 27 are for example the same as those described in the application US 20120298091.

The machine 2 also comprises a system 28 for controlling and adjusting the twisting of the wire 10. This system 28 comprises:
a controllable device 29 for twisting the abrasive wire 10,
a fixed sensor 30 capable of measuring a physical quantity representative of the shape of a mark produced on the outer face of the wire 10, and
a processing unit 32 programmed to estimate the twisting of the wire 10 from the measurements of the sensor 30 and to control the device 29 as a function of the estimated twisting.

The twisting device 29 makes it possible, in response to a command from the processing unit 32, to increase and, alternately, to reduce the twisting of the wire 10. An exemplary embodiment of this device 29 is described in more detail with reference to FIG. 4.

The processing unit 32 comprises a programmable microprocessor 34 capable of executing instructions stored in a non-volatile memory and a memory 36 connected to the microprocessor 34. The memory 36 comprises the instructions and the data necessary to execute the method of FIG. 6.

The processing unit 32 is connected to the sensor 30 and to the twisting device 29.

FIGS. 2 and 3 represent the wire 10 in more detail. The wire 10 extends along a longitudinal axis 40. It comprises a central core 42 onto which are fixed abrasive particles 44 held on the central core by a binder 46. Thus, the wire 10 has an outer face 48 from which the abrasive particles 44 protrude.

The outer face 48 here corresponds to the outer face of the binder 46 situated between the abrasive particles 44. The outer face 48 is cylindrical and completely encircles the axis 40. Here, the outer face 48 is centered on the axis 40. In FIG. 2, the cross section of the outer face 48 is circular. In reality, because of variations of the thickness of the binder 46 and a lack of precision on the geometry of the cross section of the core 42, the cross section of the outer face 48 is not a perfect circle. However, initially and on average over all the length of the wire 10, it does approach that.

Typically, the central core 42 takes the form of a single wire having a tensile strength greater than 2000 MPa or 3000 MPa and, generally, less than 5000 MPa. The elongation at break of the core 42 is greater than 1% and, preferably, greater than 2%. Conversely, the elongation at break of the core 42 must not be too great and, for example, must remain below 10% or 5%. The elongation at break here represents the increase in the length of the core 42 before the latter breaks.

In this embodiment, the core 42 has a circular cross section. For example, the diameter of the core 42 lies between 10 μm and 150 μm and, often, between 70 μm and 150 μm. In this example, the diameter of the core 42 is equal to 120 μm. Here, the core 42 is produced in an electrically conductive material. A material is considered to be electrically conductive if its resistivity is less than 10⁻⁵ Ω·m at 20° C. For example, the core 42 is produced in steel, such as a carbon steel or a ferritic stainless steel or a brass plated steel. In this example, the core 42 is made of steel with 0.8% by weight of carbon. The weight per unit of length m of the core 4 is, for example, between 10 mg/m and 500 mg/m and, preferably, between 50 mg/m and 200 mg/m.

The abrasive particles 44 form saw teeth on the face 48 which erode the material to be cut. These abrasive particles must therefore be harder than the material to be cut. Typically, the abrasive particles exhibit a hardness greater by at least 42 Hv or 100 Hv than that of the ingot to be cut. To this end, each abrasive particle is formed from a material whose hardness is greater than 430 Hv on the Vickers scale and, preferably, greater than or equal to 1000 Hv. On the Mohs scale, the hardness of this material is greater than 7 or 8. Typically, this material represents more than 80% or 90% of the volume of the abrasive particle. For example, the particles 44 are diamonds. These diamonds can be multicrystalline diamonds often referred to as “RB diamonds” (RB being the acronym for “resin bond”) or so-called “hyperion” monocrystalline diamonds such as those described in the application WO 2011014884 and sold by the company Sandvik Hyperion®. The hardness of an abrasive particle can be estimated from their chemical composition, and from their crystalline structure, and as a function of the data published on the hardnesses of the different minerals.

The sizes of the particles 44 are distributed according to a probability law. Here, by way of example, the distribution of the sizes of the particles 44 is such that:
the minimum diameter of the particles 44 at 5%, called D5, is greater than 5 μm, and
the maximum diameter of the particles 44 at 95%, called D95, is less than 40 μm and less than a third of the diameter of the core 42.

The diameter D95 is a value such that 95%, by volume, of the particles 44 of the wire 10 have a diameter less than D95. In other words, only 5%, by volume, of the particles 44 of the wire 10 have a diameter greater than D95. The diameter D5 is a value such that only 5%, by volume, of the particles 44 of the wire 10 have a diameter less than D5. In other words, 95%, by volume, of the particles 44 of the wire 10 have a diameter greater than D5. The diameter of the particles 44 is measured by a Coulter counter. The measurement method is described in the standard ISO 13319:2000 “Determination of particle size distribution—Electrical sensing zone method” or the revised standard ISO 13319:2007. To separate the abrasive particles from the wire, the latter is dipped in an aqueous solution containing nitric acid. The metals of the core and of the binder are dissolved, while the insoluble abrasive particles are released. They are then removed and rinsed, before the measurement of their particle size. The diameter indicated corresponds to the diameter of the sphere which would behave identically in the particle size analysis by Coulter counter.

Preferably, the diameter D95 is less than 42 μm or 25 μm. For example, advantageously, the diameter D5 is greater than 8 μm and the diameter D95 is less than or equal to 25 μm or 42 μm. Here, the diameter D5 is equal to 12 μm, and the diameter D95 is equal to 25 μm.

The density of abrasive particles of the wire 10 is here expressed as a number of abrasive particles per millimeter of wire. This density of abrasive particles is measured by the following method:

1) At least four samples of more than 1 mm of length of the wire 10 are taken. These samples are taken over a useful section of the wire used to cut the ingot 4 and, preferably, taken at points uniformly distributed over this useful section.
2) Each sample is inserted into a support which makes it possible to both:
hold the sample by exposing a front side of this sample to an observation device such as an electron or optical microscope, and
to pivot the sample by 180° about its longitudinal axis in order to observe the rear side of the sample which was hitherto hidden.
   3) A section of the sample of length L is selected, where L is a length greater than or equal to 0.9 mm and generally less than or equal to 1 cm or 10 cm. Next, the number of abrasive particles 44 visible on the front side of this selected section is counted. So as not to count twice the abrasive particles which are visible on both sides, that is to say those whose image extends beyond the edge of the sample, these abrasive particles visible on both sides increment the counter only by 0.5 whereas the abrasive particles visible only on the front side increment this same counter by 1. In FIG. 3, two abrasive particles 44A visible on both sides are illustrated. In this counting, an agglomerate or a cluster of several abrasive particles counts for only one. In FIG. 3, such an agglomerate 44B of abrasive particles is illustrated. In such an agglomerate, the different abrasive particles 44 are directly in mechanical contact with one another and the whole therefore forms only a single abrasive particle.
   4) The number of diamonds is counted in the selected section but, this time, on the rear side. For that, the procedure is the same as in the point 3) for the rear side of the sample after having pivoted this sample by 180° about its longitudinal axis.
   5) The density of abrasive particles for this sample is then obtained by dividing the aggregate of the number of abrasive particles counted on the front and rear sides by the length L of the selected section, expressed in mm.
   6) The density of abrasive particles of the wire 10 is taken to be equal to the average of the densities of abrasive particles measured on each of the samples.

The density of particles 44 of the wire 10 is greater than 1 abrasive particles per millimeter and, preferably, greater than 10 or 30 abrasive particles per millimeter. The density of particles 44 is generally less than 300 abrasive particles per millimeter. The industrial cutting devices typically require at least 1 km of abrasive wire and, often, at least 2 km of abrasive wire. Consequently, the density of particles 44 of the wire 10 is kept within the ranges of densities given above over a continuous useful section of the wire 10 at least 1 km or 2 km long. Typically, over this useful section of the wire 10, the density of particles 44 is constant to within plus or minus 5% or 10%. Moreover, preferably, this useful section represents at least 80% or 90% of the total length of the wire 10. Here, for example, the useful section is equal to the total length of the wire 10.

The function of the binder 46 is to keep the abrasive particles 44 fixed with no degree of freedom on the core 42. The binder 46 is, here, a metal binder because these binders are harder than resins and therefore make it possible to more effectively keep the abrasive particles on the core 42. Thus, the hardness of the binder 44 is greater than 450 Hv or 500 Hv on the Vickers scale. To this end, here, the binder is an alloy of nickel and cobalt such as that described in the application FR 3005592. For example, it comprises 20% to 40% by weight of cobalt. In this example, the binder 46 comprises 70% nickel and 30% cobalt, these percentages being given relative to the weight of the binder. The hardness of the binder 44 is then equal to 650 Hv on the Vickers scale to within plus or minus 10%.

For example, in practice, the hardness of the binder is measured by instrumented nano-indentation, by following the recommendations of the standards ISO 14577-1:2002 and ISO 14577-4:2007. However, these standards cannot be strictly followed, because indenters are generally situated too close to the edges of the binder. The hardness obtained is then expressed in GPa. This GPa value is converted into Vickers hardness by applying the Oliver and Pharr method to the observed charge and discharge curves. This is why the charge in grams force is not given in the expression of the Vickers hardness. Here, for the measurement by nano-indentation, a Berkovich penetrator, a force of 10 mN and a time of 15 seconds have been employed.

The thickness of the binder 46 is chosen to have an exposure of the abrasive particles of between Emin and Emax, where Emin is strictly less than Emax. To this end, the thickness of the binder 46 lies between Tbo_min and Tbo_max. Here, Emin is greater than or equal to 110% and, preferably, to 65%, and Emax is less than or equal to 90%. The computation of the exposure E of an abrasive particle is then described in the application WO 2011014884 with reference to FIG. 3b. It is recalled here that the exposure E of a particle is given by the following relationship:

E=100*(Tco−Tbo)/Tco, in which:
Tco is the shortest distance between the vertex of the particle 44 furthest away from the surface of the core 42 and the projection, in a radial direction, of this vertex onto the surface of the core 42, and
Tbo is the thickness of the binder 46.

Here, the minimum exposure Emin of the particles 44 is computed by considering that Tco is equal to the diameter D5 and that the thickness of the binder 46 is maximal, that is to say equal to Tbo_max. The maximum thickness Tbo_max of the binder 46 which makes it possible to comply with the minimum exposure Emin is therefore given by the following relationship: Tbo_max=D5*(1−Emin/100). Likewise, the maximum exposure Emax of the particles 46 is calculated by considering that Tco is equal to the diameter D95 and that the thickness of the binder 46 is minimal, that is to say equal to Tbo_min. The minimum thickness of binder 46 which makes it possible to comply with the maximum exposure Emax is then given by the following relationship: Tbo_min=D95*(1−Emax/100). The thickness of the binder 46 is chosen between Tbo_min and Tbo_max. Thus, for abrasive particles of diameters D5 and D95 equal, respectively, to 8 μm and 16 μm, the thickness of the binder is chosen between 1.6 μm and 4 μm to obtain a mean exposure of between 110% and 90%. For particles 44 whose diameters D5 and D95 are equal, respectively, to 12 μm and 25 μm, the thickness of the binder 46 is chosen between 2.5 μm and 4.5 μm to obtain a mean exposure of between 60% and 90%. Here, the thickness of the binder 46 is chosen to be equal to 4 μm.

The thickness of the binder notes its mean thickness between the particles 44. For example, to measure the thickness of the binder 46, the wire 10 is cut transversely at at least four different points distributed along its length. Four cross sections of the wire 10 are thus obtained, similar to that represented in FIG. 2. On each of these sections, the thickness of the binder 46 is measured at at least four points. The measurement points are situated between the particles 44. Preferably, these measurement points are uniformly distributed over the periphery of the cross section. For example, at each measurement point, the thickness is measured using an electron microscope. In fact, the limit between the core 42 and the binder 46 can be seen in these sections. Next, the thickness of the binder 46 is taken to be equal to the mean of all the measurements obtained on each of the cross sections.

In this embodiment, the binder 46 is deposited in two successive layers 50 and 52 by electrolysis. The thickness of the layer 50 is small. It is for example less than a third of the median diameter of the abrasive particles. This layer 50 simply makes it possible to weakly fix the particles 44 on the central core.

The layer 52 has a greater thickness. For example, the thickness of the layer 52, in the radial direction, is 1.5 or two times greater than the thickness of the layer 50. This layer 52 makes it possible to prevent the tearing away of the abrasive particles 44 when the wire 10 is used to cut the ingot 4.

The wire 10 is for example manufactured as is described in the application FR 2988629.

The face 48 comprises a mark 54 whose shape varies as a function of the twisting of the wire 10. The face 48 also comprises a contrast zone 56 which makes it possible to observe the angular position of the mark 54. Such an abrasive wire comprising such a mark is hereinafter called “marked abrasive wire”.

The mark 54 extends continuously and parallel to the axis 40 over the useful section of the wire 10. It extends over at least 62.5% and, preferably, over at least 80% or 90% of this useful section. Here, by way of illustration, the mark 54 extends over all the length of the wire 10.

In all the transverse planes of the wire 10 where the mark 54 is present, this mark 54 extends from a right side 60 to a left side 62 of an angular segment 64. The vertex of the angular segment 64 is situated on the axis 40. This angular segment 64 is hereinafter called “marked angular segment”. The angle at the vertex of the angular segment 64 is denoted α. For the mark 54 to be easily observable, the angle α is greater than or equal to 0.5° or 1° and, preferably, greater than or equal to 45° or 60°. Furthermore, for all of the mark 54 to be able to be observed from a single side of the wire 10, the angle α is less than 180° or 150°. Here, the angle α is equal to 60°.

In this embodiment, in the absence of twisting of the wire 10, the position of the angular segment 64 is constant and independent of the value of the curvilinear abscissa where the cross section of the abrasive wire is observed. In other words, in the absence of twisting, the position of the angular segment 64 about the axis 40 is the same over all the length of the mark 54. Thus, when the wire 10 is held taut between its ends and therefore the axis 40 is rectilinear, the mark 54 is also rectilinear and extends parallel to this axis 40 in the absence of twisting. Conversely, if the wire 10 exhibits a non-zero twisting, in the same conditions, the mark 54 forms a helix whose axis coincides with the axis 40. Thus, the shape of this mark varies as a function of the twisting of the wire 10.

Here, the mark 54 is produced in a material whose reflectance Rₘ is less than 20% at the wavelength λₘ. Furthermore, the mark 54 is produced in a material which remains fixed on the face 48 even in the presence of the liquids that are usually sprinkled on the wire 10 during the sawing of the ingot 4. Thus, typically, the chosen material is insoluble in water.

For example, the material used to produce the mark 54 is a black indelible ink. As an illustration, it can be the same black ink as that used in the Staedler® Lumocolor® marker of reference 350-9. Such an ink can be deposited on the wire 10, for example, using an inking roller which rolls, in the direction X, over the wire 10 and which is in contact with the face 48 only within the angular segment 64. Rather than using an inking roller or pad, it is also possible to spray the ink in the angular segment 64 using a print nozzle similar to that used in ink-jet printers.

In the case of a black ink, the reflectance of the mark 54 is less than 20% throughout the visible spectrum, that is to say between 0.4 μm and 0.7 μm. Furthermore, this reflectance Rₘ remains also less than 20% in the infrared spectrum lying between 0.7 μm and 100 μm and, in particular, in the near infrared spectrum lying between 0.7 μm and 1.6 μm. Thus, with such a mark 54, the wavelength λₘ can be chosen between 0.4 μm and 100 μm. Hereinbelow, by way of illustration, the wavelength λₘ is chosen in the visible spectrum, that is to say between 0.4 μm and 0.7 μm.

The contrast zone 56 makes it possible to identify the position of the sides 60 and 62 of the mark 54. To this end, the zone 56 exhibits a reflectance R_{f} at the wavelength λₘ substantially different from that of the mark 54. Throughout this text, the reflectances are expressed as a percentage. “Substantially different” denotes the fact that the difference between the reflectances Rₘ and R_{f} is such that |Rₘ−R_{f}| is greater than or equal to 5% and, preferably, greater than or equal to 20% or 40%.

Here, at the points where the face 48 is not covered by the mark 54, this outer face is composed of the metal binder 46. The reflectance at the wavelength λₘ of the binder 46 is greater than or equal to 80% or 90%. Thus, in this embodiment, to obtain the contrast zone 56, it is not necessary to cover the zone 56 with a material deposited directly on this face 48.

The zone 56 extends, in the transverse plane, along the sides 60 and 62 of the mark 54 over all the length of the mark 54. To this end, in this embodiment, the zone 56 extends in each transverse plane where the mark 54 is present from the side 62 to the side 60 of a contiguous angular segment 70. The vertex of the angular segment 70 is situated on the axis 40. The angular segment 70 is, here, the angular segment complementing the angular segment 64. In other words, the combination of the angular segments 64 and 70 extends over 360°. Here, the angular segment 70 is therefore equal to 360°−α. For the mark 54 to be able to be detected, the angular segment 70 is, preferably, greater than or equal to 0.5°.

FIG. 4 presents an exemplary embodiment of the twisting device 29. In this embodiment, the device 29 comprises a bottom wheel 80 and a top wheel 82 which grip the wire 10 between them. At least the tread of each of these wheels 80 and 82 is directly in contact with the wire 10. This tread is produced in a material which exhibits a strong coefficient of friction with the wire 10. For example, the tread is produced in polyurethane of low hardness or in rough ceramic. Here, the wheels 80 and 82 are mounted to rotate freely about, respectively, axes 84 and 86.

The device 29 also comprises two controllable actuators 88 and 90. The actuators 88 and 90 are capable of modifying the inclination, respectively, of the axes 84 and 86 relative to a vertical plane PV containing the axis 40 of the wire 10. Several specifically, here, these actuators are programmed to systematically keep the axes 84 and 86 symmetrical to one another relative to this plane PV. The angle between the plane PV and the axis 84 is denoted θ.

In these conditions, when the wire 10 is displaced in translation in the direction X and the angle θ is non-zero, the wire 10 drives the wheels 80 and 82 in rotation in directions that are the reverse of one another. This rotation of the wheels 80 and 82 drives a rotation of the wire 10 about the axis 40 and therefore generates a twisting of the wire 10 as a function of the angle θ. More specifically, as long as the angle θ lies within the interval ]0°; 45] or ]0°; −45°], the more the absolute value of the angle θ increases, the more the twisting increases. Within the interval]0°; −45°], the twisting is of opposite direction to that obtained in the case where the angle θ lies within the interval ]0°; +45°]. The symbol «]» means that the value which follows it does not lie within the interval.

FIG. 5 represents in more detail an exemplary embodiment of a sensor 30. This sensor 30 is a sensor of the reflectance of the face 48 of the wire 10 at the wavelength λₘ. Here, this sensor 30 is arranged to be only sensitive to the reflectance of the face 48 situated within an angular segment 100 whose vertex is situated on the axis 40. This angular segment 100 is less than or equal to 180° and, preferably, greater than or equal to the angular segment 64. Here, the angular segment 100 is chosen equal to the angular segment 64. Thus, when the mark 54 is exactly opposite the sensor 30, it occupies all of the angular segment 100 as represented in FIG. 5. In these conditions, the measured reflectance is minimal when the mark 54 occupies the predetermined angular position in which it is exactly opposite the sensor 30. The position of the sensor 30 relative to the wire 10 is, here, constant.

For example, the sensor 30 comprises a single transducer 102 and a focusing device 104. The transducer 102 measures the reflectance at the wavelength λₘ and transforms it into an electrical signal transmitted to the processing unit 32. Typically, the transducer 102 comprises a single face sensitive to the reflectance unlike transducers equipped with several pixels. The focusing device 104 focuses, toward the sensitive face of the transducer 102, the electromagnetic waves at the wavelength λₘ reflected by the face 48 situated only within the angular segment 100. It will be noted here that the sensor 30 does not include any light source which emits an incident radiation onto the outer face 48 at the wavelength λₘ. In effect, it is considered here that this source consists of the visible light from the external environment in which the machine 2 is situated.

The method for cutting the ingot 4 using the machine 2 will now be described with reference to the method of FIG. 6.

Initially, most of the wire 10 is wound on the reel 14.

In a step 110, the motors 18 and 20 are controlled to wind off a length L1 of wire 10 from the reel 14 and, at the same time, wound a length L1 of wire 10 around the reel 16. The wire 10 is then displaced in the direction X.

In a step 112, once a length L1 of the wire 10 has been wound off from the reel 14, the control of the motors 18 and 20 is reversed so as, this time, to wind off a length L2 of wire 10 from the reel 16 and, at the same time, wind this length L2 of wire 10 around the reel 14. Thus, during the step 112, the wire 10 is displaced in the opposite direction to the direction X.

When the length L2 of wire 10 has been wound onto the reel 14, the step 112 is stopped and the method returns to the step 110.

Generally, the length L2 is shorter than the length L1 so that, on each execution of the step 110, a length L1-L2 of new wire is injected between the two reels 14 and 16. Typically, the difference between L2 and L1 is less than 2% or 1.5% of the length of the wire 10. Here, this difference is equal to 1% of the length of the wire 10 to within plus or minus 10%.

On each execution of the steps 110 and 112, the wire 10 rubs on the ingot 4, which little-by-little causes, by abrasion, a saw line to be hollowed out in the top face of this ingot. At the same time, the ingot 4 and the wire 10 are generally sprinkled by a liquid. The latter is generally composed of water and one or more soluble lubricants. The lubricant concentration generally lies between 0.5% and 10% by volume.

In parallel with the steps 110 and 112, in a step 114, the actuator 12 advances the ingot 4 in the direction Z to maintain a good mechanical contact between the ingot 4 and the wire 10.

Also in parallel, in a step 116, the mechanisms 26 and 27 lock the mechanical tension of the wire 10 onto a mechanical tension setpoint CT. Preferably, this setpoint CT is chosen so that the tension of the wire 10 on the reels 14 and 16 is less than or equal to half the ultimate tensile stress supported by this wire 10. For example, in the case of the wire 10 described here, the ultimate tensile stress is 43 N to within plus or minus 15%. The mechanical tension setpoint is therefore chosen to be less than 21.5 N. This makes it possible to increase the lifespan of the wire 10.

Also in parallel with the preceding steps, in a phase 118, the system 28 monitors and automatically adjusts the twisting of the wire 10. For that, in a step 120, the system 28 records a characteristic C₁ of the current shape of the mark 54. Here, the characteristic C₁ used is the number of times, per unit of length, where the mark 54 is detected in a predetermined angular position. In this embodiment, the predetermined angular position corresponds to the position where the mark 54 is exactly opposite the sensor 30.

For that, in an operation 122, the sensor 30 permanently measures the reflectance of the outer face 48 only situated within the angular segment 100. The measured signal is transmitted in real time to the processing unit 32.

In an operation 124, each time a new reflectance measurement is received by the processing unit 32, the latter searches for the presence of the mark 54 opposite the sensor 30. For that, the processing unit 32 determines, from the measurements of the sensor 30, whether the measured reflectance passes through a minimum. If it does, the presence of the mark 54 opposite the sensor 30 is detected. Otherwise, it is the absence of the mark 54 opposite the sensor 30 which is detected. Here, each time the mark 54 is detected as being opposite the sensor 30, the instant tᵢ at which this is detected is recorded in the memory 36.

Then, at predetermined intervals, in an operation 126, the processing unit 32 calculates the characteristic C₁ from the instants tᵢ recorded in the memory 36. For example, the processing unit 32 calculates the characteristic C₁ using the following relationship: C₁=N/[(t_{c}−t_{c-p})V], in which
t_{c} is the most recent instant tᵢ at which the mark 54 was detected
p is an integer number greater than or equal to one and, preferably, greater than or equal to two;
t_{c-p} is the p^{th} instant tᵢ preceding the instant t_{c};
V is the average speed of the wire 10 during the time interval [t_{c-p}; t_{c}]; and
N is the number of times the mark 54 has been detected in the interval]t_{c-p}; t_{c}].

Finally, in a step 126, the processing unit 32 estimates the twisting of the wire 10 from the current value of the characteristic C₁ and from a known value of this characteristic C₁ corresponding to a known twisting of the wire 10. Here, the shape of the mark 54 is known in the case where the twisting of the wire 10 is zero. In effect, as described previously, in the absence of twisting, the mark 54 is rectilinear. When the mark 54 is rectilinear, there are two possible cases:

1) either it is never detected by the sensor 30 because it is never opposite the sensor 30,
2) or it is detected permanently because it is always opposite the sensor 30.

In the case 1), the value of the characteristic C₁ is zero. In the case 2), the value of the characteristic C₁ is equal to Fₑ/V, in which Fₑ is the frequency of sampling of the reflectance measured by the sensor 30. Thus, a very high value of the characteristic C₁ corresponds also to a zero twisting. By contrast, between these two extreme cases, the value of the characteristic C₁ varies in proportion to the twisting of the wire 10. Consequently, the processing unit 32 estimates the twisting Toₑ of the wire 10, for example, using the following relationship:
Toₑ=2πC₁ if C₁ is different from Fₑ/V and zero, and
otherwise Toₑ=0.

In this description, the number of turns of the wire 10 about the axis 40 is expressed in radians such that a complete turn is equal to 2π.

Finally, here, in a step 132, the processing unit 32 controls the twisting device 29 as a function of the estimation Toₑ. Here, whatever the control strategy applied, the latter aims to systematically keep the twisting of the wire 10 below a predetermined threshold STo_{Max}. In fact, a significant twisting of the wire 10 embrittles it and risks provoking a premature breaking of this wire. Here, the threshold STo_{Max} is less than or equal to the value of the twisting of the wire 10 for which its tensile strength is equal to 50% of the tensile strength of the wire 10 in the absence of twisting. For example, the threshold STo_{Max} is less than or equal to 20 π/cm or 10 π/cm. At this stage, many control strategies are possible to systematically keep the twisting of the wire 10 below the threshold STo_{Max}. For example, the processing unit 32 compares the absolute value of the estimation Toₑ to the threshold SToₘₐₓ. If the estimation Toₑ exceeds the threshold STo_{Max}, the processing unit 32 automatically controls the device 29 to reduce the twisting of the wire or automatically stops the operation of the machine 2 or even triggers an alarm to inform an operator.

In another embodiment or in addition to what has just been described, the processing unit 32 locks the twisting of the wire 10 onto a twisting setpoint Cₜₒ that is less than, as an absolute value, the threshold STo_{Max}. Typically, in this case, the processing unit 32 controls the device 29 to permanently minimize the difference between the setpoint Cₜₒ and the estimation Toₑ. Advantageously, the setpoint Cₜₒ is modified at regular intervals to reverse the direction of twisting of the wire 10. Thus, the twisting of the wire 10 which rubs on the ingot 4 is both in one direction and in the opposite direction. That makes it possible to uniformly distribute the wear of the wire 10 over all its outer periphery.

FIG. 7 represents an abrasive wire 140 identical to the wire 10 except that the mark 54 is replaced by a mark 142. The mark 142 is for example identical to the mark 54 except that it is not continuous over all the length of the useful section of the wire 10. For example, the mark 142 is present only in sections Trᵢ distributed at regular intervals over all the length of the useful section of the wire 140. Between two successive sections Trᵢ, the mark 140 is absent. The length of the sections Trᵢ is, for example, greater than or equal to 1 cm or 5 cm and generally less than or equal to 50 cm or 30 cm. Here, all the sections Trᵢ have the same length LTrᵢ. The length of the interval Iᵢ between the sections Trᵢ and Trᵢ₊₁ is for example greater than or equal to 1 cm or 5 cm and, generally, less than or equal to 50 cm or 30 cm. Here, all the intervals Iᵢ have the same length LI.

In FIG. 7 and the subsequent figures, the vertical wavy lines indicate that only the start and the end of the wire have been represented in this figure to simplify it.

When the wire 140 is used in place of the wire 10, the presence of intervals without mark arranged regularly along the length of the wire 140 generates a periodic component in the reflectance measured by the sensor 30. This periodic component can, for example, be used to deduce therefrom the speed of the wire 140 since the lengths LI and LTrᵢ are known.

FIG. 8 represents an abrasive wire 150 identical to the wire 10 except that the mark 54 is replaced by three contiguous marks 152, 154 and 156 produced on the outer face 48. For example, the mark 152 is, here, identical to the mark 54 except that it extends from one side 158 to an opposite side 160 of an angular segment 162. The angular segment 162 is equal to 120° and its vertex is situated on the axis 40.

The mark 154 is identical to the zone 56 except that it extends only from the side 160 to an opposite side 164 of an angular segment 166. The vertex of the angular segment 166 is on the axis 40 and this angular segment 166 is, here, equal to 120°.

The mark 156 extends from the side 158 to the side 164 of an angular segment 168. The angular segment 168 therefore also forms 120°.

The reflectance Rₘ₁₅₂ of the mark 152 at the wavelength λₘ is substantially different from the reflectances Rₘ₁₅₄ and Rₘ₁₅₆, respectively, of the marks 152 and 154. Furthermore, here, the reflectances Rₘ₁₅₄ and Rₘ₁₅₆ are also substantially different from one another. For example, the reflectances Rₘ₁₅₂, Rₘ₁₅₄ and Rₘ₁₅₆ are equal, respectively, to 10%, 50% and 90% at the wavelength λₘ. Thus, for the mark 152, it is the marks 154 and 156 which fulfill the contrast zone function previously described in the particular case of the zone 56. Likewise, for the mark 154, it is the marks 152 and 156 which bracket it which fulfill the contrast zone function. The same applies for the mark 156.

When the wire 150 is used in place of the wire 10, the processing unit 32 is capable of detecting the direction of twisting of this wire. In effect, for example, when the wire 150 is twisted in the clockwise direction, the processing unit 32 successively detects the marks 152, 154 and 156. Conversely, if the wire 150 is twisted in the opposite direction, the processing unit 32 successively detects the marks 152, 156 and 154. Thus, the presence of at least three marks of different reflectances on the face 48 makes it possible, in addition, if necessary, to detect the direction of rotation of the abrasive wire.

FIG. 9 represents an abrasive wire 180 identical to the wire 10. Except that the mark 54 is replaced by a mark 182. The mark 182 is identical to the mark 54 except that, in the absence of twisting, the mark 182 forms a helix whose axis coincides with the axis 40 and whose pitch P is known in the absence of twisting. In other words, in this embodiment, the angular position of the angular segment 64 rotates about the axis 40 with a period P as it is moved along the axis 40. When the twisting of the wire 180 increases in the counter-clockwise direction, the pitch of the helix decreases. When the twisting of the wire 180 increases in the opposite direction, the pitch of the helix increases. Thus, when the wire 180 is used in place of the wire 10, the characteristic representative of the current shape of the mark 180 recorded in the step 120 is for example the frequency F_{T} of detection of the mark 180. In the absence of twisting, this frequency F_{T} is equal to V/P. When the twisting increases in the counter-clockwise direction, the frequency F_{T} decreases and when the twisting increases in the reverse direction, the frequency F_{T} increases. Thus, the use of the frequency F_{T} makes it possible, if necessary, to also determine the direction of twisting of the abrasive wire 180.

FIG. 10 represents a roll 190 comprising the reel 14 and the wire 10 wound on this reel 14. In this embodiment, at least the useful section of the wire 10 wound on the reel 14 is divided into a succession of successive segments Sᵢ. The index “i” is the order number of the segment Sᵢ counted from an end of the wire 10. Each segment Sᵢ of the wire 10 forms, generally, at least 1 m long and, more often, less than 500 m or 100 m long. For example, here, all the segments Sᵢ have the same length LS. The length LS lies between 1 m and 100 m and, for example, the number Nₚ of segments Sᵢ is greater than or equal to two and generally greater than or equal to 10 or 50.

Within each segment Sᵢ, the wire 10 turns systematically in the same direction and forms Nᵢ turns about the axis 40. By convention, if the wire 10 turns in the counter-clockwise direction within the segment Sᵢ, the number Nᵢ is positive. Conversely, if the wire 10 turns in the direction opposite to the counter-clockwise direction within the segment Sᵢ, the number Nᵢ is negative. The number Nᵢ is not necessarily an integer number. It can be a real number because it is not necessary for the wire 10 to make an integer number of turns within a segment Sᵢ. Whatever the index i, the absolute value of the number Nᵢ is greater than or equal to one and, preferably, greater than or equal to 5 or 10.

Furthermore, whatever the index i, the two segments Sᵢ and Sᵢ₊₂ within which the wire 10 turns in the same direction are systematically separated from one another by a segment Sᵢ₊₁ in which the wire 10 turns in the reverse direction.

Within each segment Sᵢ, the twisting is sufficiently weak for the torsional deformation of the wire 10 to be elastic. To this end, the twisting of the wire within any segment Sᵢ is less than 5 turns/cm or 1 turn/cm.

Preferably, for the twisting of the wire to remain below the threshold SToₘₐₓ, the aggregate of the numbers Nᵢ of each segment Sᵢ of the abrasive wire is less than or equal to Max[(|Nᵢ|+|Nᵢ₊₁|)/4] or Max[|Nᵢ+Nᵢ₊₁|], in which:
“Max[ . . . ]” is the function which returns the maximum for any i varying from 1 to Nₚ, of the sum contained between the square brackets, and
“| . . . |” is the absolute value function.

Since the deformation is elastic, as soon as a segment Sᵢ is wound off from the reel 40 and, if it is free to rotate on itself, it then turns on itself to reduce its twisting. At best, it turns sufficiently on itself until its twisting on this segment is zero, that is to say until it reverts to an initial state in which the number of turns of the wire 10 within the segment Sᵢ is zero.

Conversely, when the segment Sᵢ is wound on the reel 14, because of the frictions on the reel 14 and on the other turns of the wire 10 already wound on this reel, the segment Sᵢ is rotationally immobile about the axis 40.

Here, it is in the first winding of the wire 10 on the reel 14 that a twisting in one direction and, alternately, in an opposite direction, is applied to the wire 10 to create the different segments Sᵢ successively wound on the reel 14.

Then, in the use of the roll 190 in the machine 2, when a segment Sᵢ is wound off from the reel 14, that rotationally drives the abrasive wire 10 in one direction. Next, when it is the next segment Sᵢ₊₁ which is wound off, that rotationally drives the wire 10 in an opposite direction. By virtue of that, the wear of the wire 10 is distributed more uniformly over all its periphery. Furthermore, for that, it is not necessary to provide a twisting device to turn the wire 10 about its axis 40 both in one direction and in the opposite direction. For example, the twisting device 29 is omitted. In this case, the monitoring system 28 is used only to monitor the twisting of the wire 10 to ensure that it does not exceed the threshold SToₘₐₓ. In case of this threshold being exceeded, the system 28 will then trigger an alarm or automatically stop the sawing of the ingot 4 in order for an operator to be able to intervene and correct the problem. When the device 29 is omitted, the system 28 cannot automatically adjust the twisting of the wire 10.

Variants of the Mark:

The number of marks simultaneously distributed on the face 48 of the abrasive wire can be greater than or equal to two or three. As described with reference to FIG. 8, if these marks have reflectances that are substantially different from one another at the wavelength λₘ, the contrast zone between these different marks can be omitted. By contrast, if such is not the case, a contrast zone as described with reference to FIGS. 2 and 3 can be interposed between each different mark.

In another embodiment, it is the contrast zone which is entirely covered with black ink and the mark 54 which is directly composed of the outer face of the binder 46. In this case, the mark is not obtained by covering the outer face using an ink or can be covered with an ink of a different color whose reflectance is substantially different from the reflectance of the contrast zone or of the immediately contiguous marks.

In another embodiment, the contrast zone 56 is covered with a material such as a white ink to obtain the reflectance R_{f} desired for this zone 56.

The marked angular segment is not necessarily constant over all the length of the abrasive wire. For example, in a predetermined segment of the abrasive wire, the marked angular segment is equal to 60° and, in another predetermined segment of the abrasive wire, the angular segment is greater than or equal to 180°. By periodically varying the width of the angular segment, harmonics whose frequency is representative of the speed of the abrasive wire are generated in the signal measured by the sensor 30.

In the case where the abrasive wire comprises several marks, at least some of them can fulfil the contrast zone function for another of these marks.

In the embodiment of FIG. 7, the length of the sections Trᵢ or of the intervals Iᵢ are not necessarily all identical.

The known initial shape of the mark is not necessarily that which corresponds to a zero twisting of the abrasive wire. For example, if the abrasive wire is wound on the reel 14 with a known, non-zero initial twisting, then the known initial shape can be the shape of the mark when the twisting of the abrasive wire is equal to this known and non-zero initial twisting.

Initially, the mark may or may not cover the abrasive particles 44. This is unimportant since, from the start of the sawing of the ingot 4, the ink which covers the abrasive particles is erased because of the friction of these abrasive particles against the ingot 4.

Other materials can be used to produce the mark. For example, the material used can be copper or gold. To deposit copper or gold only in the angular segment 64, the angular segment 70 is for example first covered with an electrically insulating material and one which can then be easily removed. For example, this electrically insulating material is oil, grease or glue. The electrically insulating material is deposited on all the outer surface except in the locations where the mark must be deposited. Then, the wire covered with the electrically insulating material is dipped in an electrolyte bath and the copper and/or the gold is deposited on the outer face of the abrasive wire by electrodeposition. Finally, the electrically insulating material is removed. In the case where the material of the mark is copper or gold, the wavelength λₘ is preferably chosen to be less than or equal to 0.5 μm. It is also possible to use an electrodeposition pad to deposit the copper or the gold only at the desired location. In another embodiment, the material used to produce the mark is luminescent at the wavelength λₘ. For example, for that, it comprises luminescent particles. The production of such a luminescent material is described in detail in the application FR 3041650 A1. That makes it possible in particular to enhance the contrast between the reflectances Rₘ and R_{f}.

Variants of the Abrasive Wire:

As a variant, the ends of the abrasive wire are welded to one another to form a loop of marked abrasive wire. When a cutting machine uses a loop of abrasive wire, it is not necessary for the abrasive wire to be displaced in one direction and, alternately, in the opposite direction to saw the ingot 4. The cutting machine can permanently and systematically drive the abrasive wire in the same direction. In the case of a loop of abrasive wire, the length of the abrasive wire is generally less than 10 m or 5 m.

The cross section of the face 48 is not necessarily circular. What has been described previously goes also with abrasive wires whose cross section of the outer face is, for example, slightly oblong or elliptical.

In another variant, the binder 46 can be a resin.

Variants of the Cutting Machine:

The abrasive wire described in this application can also be used to set different parameters of a cutting machine without reflectance sensor and/or controllable twisting device. For example, the abrasive wire 10 is mounted in a cutting machine without reflectance sensor. Next, this machine is started up and the wire 10 is displaced between the wire guides. If the angular segment 64 is sufficiently great for the presence of the mark 54 on the outer face of the wire 10 to be visible to the naked eye, then an operator can count with the naked eye the number of times the mark 54 appears then disappears during a predetermined time. From this manual count, it is possible to estimate the frequency of appearance of the mark 54. The greater the twisting of the wire, the higher the estimated frequency of appearance. To reduce the twisting, he or she can then manually set one or more twisting devices of the cutting machine. For example, he or she can increase the concentration of lubricant to reduce the coefficient of friction between the wire guides and the abrasive wire. Increasing the concentration of lubricant reduces the grip of the abrasive wire on the wire guide, and, generally, reduces the twisting of the wire. Then, to check that the twisting of the wire is now acceptable, he or she can once again estimate with the naked eye the frequency of appearance of the mark 54. If the twisting of the abrasive wire still appears too high, he or she can once again modify the settings of the cutting machine. Otherwise, if the twisting of the abrasive wire is suitable, the setting of the cutting machine is terminated and he or she can then proceed to cut slices from the ingot of hard material.

In the cutting operations, it is not necessary for the twisting of the abrasive wire to be supervised with the naked eye or automatically using an electronic sensor.

The abrasive wire described can also be used in a cutting machine equipped with a processing unit which estimates the twisting of the abrasive wire and which does not make it possible to automatically control a twisting device for this wire. For example, the estimation of the twisting is simply communicated to an operator via a human/machine interface. In response, this operator can manually set the twisting device to increase or, on the contrary, reduce the twisting of the abrasive wire.

The sensor 30 and the twisting device 29 can be placed in locations other than those represented in FIG. 1. For example, the sensor 30 is not necessarily situated between the two wire guides 22 and 23 but can be placed between the reel 14 and the wire guide 22 or between the reel 16 and the wire guide 23.

Variants of the Sensor:

The reflectance can be measured at other wavelengths and, in particular, at wavelengths outside of the visible spectrum. For example, advantageously, the wavelength λₘ is chosen from a range of values within which the material to be cut is transparent. Here, a material is considered to be “transparent” at a given wavelength if, at this given wavelength, its transmission rate is greater than or equal to 0.6 and, preferably, greater than or equal to 0.8 or 0.9. For example, if the material to be cut is silicon, then the wavelength λₘ will advantageously be chosen from the infrared and, typically, from the range lying between 1.2 μm and 7 μm. In effect, in the case where the material cut is transparent at the wavelength λₘ, then that avoids having chips or dust from the cut material disrupting the measurement of the reflectance of the abrasive wire.

The measurement of the reflectance of the abrasive wire can also be performed, simultaneously, at several different wavelengths λₘ.

The sensor does not need to directly measure the reflectance of the outer face of the abrasive wire but can measure another physical quantity which varies as a function of the reflectances of the mark and of the contrast zones. For example, in a particular embodiment, the sensor is replaced by a camera which films the outer face of the abrasive wire which is displaced in front of its lens. This camera is a camera which films in the visible spectrum if the wavelength λₘ is situated in the visible spectrum or an infrared camera which films in the infrared range if the wavelength λₘ is situated in the infrared spectrum. Next, the processing unit 32 processes these images so as to identify the position of the mark in each of these images when the latter is present in these images. Once the position of the mark in the images has been identified, the recorded characteristic of the current shape of the mark can be the same as that previously described. However, when the images filmed by the camera each comprise several pixels, for example more than 256 pixels, it is possible to record other characteristics of the current shape of the mark which cannot be recorded using a simple reflectance sensor with a single pixel. For example, in the case of the abrasive wire 10, the inclination of the mark relative to a fixed direction, for example parallel to an edge of the image, can be recorded. The greater this inclination, the greater the twisting of the abrasive wire.

Similarly, the sensor 30 can be replaced by a hyperspectral camera which generates images comprising several pixels and in which the value of each pixel is associated with a reflectance value measured by a particular transducer of this camera.

In another embodiment of the sensor 30, the angular segment 100 is strictly greater than the angular segment 64. In this case, the reflectance is also maximum when the mark 54 is exactly opposite this sensor 30.

The focusing device 104 can be omitted.

As a variant, the sensor 30 also comprises a light source which lights the face 48 at the wavelength λₘ.

To measure the reflectance of the face 48 at a wavelength λₘ lying between 0.7 μm and 100 μm and preferably between 0.7 μm and 1.6 μm, the transducer 102 can be replaced by a transducer which measures the reflectance in the infrared. For example, the transducer 102 is replaced by a transducer marketed under the reference QTR-1A by the company AlphaCrucis®.

Variants of the Twisting Device:

Other embodiments of the twisting device are possible. For example, the twisting device can be produced by drawing from the embodiment described in the application DE 10201105500630 A1. In this case, the twisting device is identical to that described with reference to FIG. 1 except that the inclination of the axis of the reel 13 is controllable and can be modified automatically in response to a command from the processing unit 32.

As a variant, one of the wheels 80 or 82 is omitted.

The tension of the wire 10 can also be adjusted by controlling the speed of rotation of the wheels 80 and 82 instead of or in addition to controlling the inclination of their respective rotation axes.

A twisting device can also comprise a controllable mechanism which displaces, in translation along its rotation axis, one of the wire guides 22, 23 relative to the other of the wire guides 22, 23. In effect, the fact that the orthogonal projection of the wire 10 in a horizontal plane containing the axis of rotation of one of the wire guides 22, 23 cuts the axis of this wire guide with an angle different from 90°, generates a twisting of the wire 10. This embodiment of the twisting device can be used in place of the twisting devices previously described or in addition to these devices.

Other Variants:

In another variant, the mark is deposited on an abrasive wire with an inking pad as the wire 10 is wound off from the reel 14 or 16. In this embodiment, before being wound off from the reel, the abrasive wire does not have any mark.

Finally, the embodiment described with reference to FIG. 10 can be implemented to more uniformly distribute the wear over the outer periphery of the abrasive wire both in the case where this abrasive wire comprises a mark and in the case where this abrasive wire has no mark such as the mark 54.

1. A method for cutting slices from an ingot made of hard material, said method comprising the displacement between two wire guides of an abrasive wire by making it rub on the ingot and thus saw said ingot, said abrasive wire comprising:
a longitudinal axis along which it extends,
a cylindrical outer face which encircles said longitudinal axis, and
abrasive particles protruding from the cylindrical outer face,
wherein:
the use, as abrasive wire, of a marked abrasive wire also comprising, on its cylindrical outer face and between the abrasive particles:
a mark which is deformed as a function of the twisting of the abrasive wire, said mark extending longitudinally over at least 50% of the total length of the abrasive wire and having a reflectance Rm at a wavelength λm, and
at least one contrast zone which extends along each side of the mark over all the length of said mark, each contrast zone having a respective reflectance Rf at the wavelength λm such that |Rm−Rf|≥5%, wherein Rm and Rf are expressed as a percentage,
during the displacement of the wire between the two wire guides and using an electronic sensor sensitive to the reflectance of the outer face of the abrasive wire at least at the wavelength λm, the observation of at least one characteristic of the current shape of the mark which varies as a function of the twisting of the abrasive wire, and
the estimation of the twisting of the abrasive wire from the observed characteristic of the current shape of the mark and from a known value of said characteristic corresponding to a known twisting of the abrasive wire.

2. The method as claimed in claim 1, wherein the observation of at least one characteristic of the current shape of the mark comprises:
during the displacement of the abrasive wire between the two wire guides and at different locations along said abrasive wire, the measurement of the reflectance of an angular portion less than or equal to 180° of the outer face of the abrasive wire,
at different locations along the abrasive wire where the reflectance measurement has been performed, the detection of the presence and, alternately, of the absence of the mark in a predetermined angular position about the longitudinal axis of the abrasive wire from the measurements performed by the sensor, then
the computation, as characteristic of the current shape of the mark, of a quantity representative of the number of times wherein the mark is detected in the predetermined angular position per unit of length.

3. The method as claimed in claim 1, wherein the method comprises the control of a twisting device as a function of the estimated twisting so as to permanently keep the twisting of the abrasive wire below a predetermined threshold beyond which the tensile strength of the abrasive wire is halved relative to its tensile strength in the absence of twisting, said twisting device reducing the twisting of the abrasive wire according to the control.

4. An abrasive wire capable of being used in a method in accordance with claim 1, said abrasive wire comprising:
a longitudinal axis along which it extends,
a cylindrical outer face which encircles said longitudinal axis, and
abrasive particles protruding on the cylindrical outer face,
wherein the abrasive wire also comprises, on its cylindrical outer face and between the abrasive particles:
a mark which is deformed as a function of the twisting of the abrasive wire, said mark extending longitudinally over at least 50% of the total length of the abrasive wire and having a reflectance Rm at a wavelength λm, and
at least one contrast zone which extends along each side of the mark over all the length of said mark, each contrast zone having a respective reflectance Rf at the wavelength λm such that |Rm−Rf|≥5%, wherein Rm and Rf are expressed as percentages.

5. The wire as claimed in claim 4, wherein, at any location where the mark is present on the outer face of the abrasive wire:
the mark extends, in a transverse plane at right angles to the longitudinal axis of the abrasive wire, from one side to an opposite side of a marked angular segment whose vertex is situated on the longitudinal axis, said marked angular segment being less than or equal to 180° and greater than or equal to 0.5°;
each contrast zone extends, in the transverse plane, from one side to an opposite side of a contiguous angular segment whose vertex is situated on the longitudinal axis of the abrasive wire, said contiguous angular segment being greater than 0.5° and immediately contiguous to the marked angular segment.

6. The wire as claimed in claim 5, wherein the marked angular segment is greater than or equal to 60°.

7. The wire as claimed in claim 4, wherein the wavelength λm lies between 0.4 μm and 0.7 μm.

8. The wire as claimed in claim 4, wherein, in the absence of twisting of the abrasive wire, the position of the marked angular segment about the longitudinal axis of the abrasive wire is constant over all the length of the mark or varies with a known period over all the length of the mark.

9. The wire as claimed in claim 4, wherein the density of abrasive particles over more than 70% of the length of the abrasive wire is greater than or equal to ten abrasive particles per millimeter.

10. A roll of abrasive wire comprising:
a reel, and
an abrasive wire wound on said reel,
wherein:
the abrasive wire is in accordance with claim 4, and said wound abrasive wire is divided into Np successive segments Si distributed over the length of the abrasive wire, the index i being the order number of the segment Si, the origin of said order number being one of the ends of the wire,
between the start and the end of each segment Si, the abrasive wire makes Ni turns about its longitudinal axis always in the same direction, where Ni is a non-zero real number that is positive if the abrasive wire turns in the counter-clockwise direction and negative if the abrasive wire turns in the opposite direction, the absolute value of the number Ni always being greater than or equal to one,
any two segments Si and Si+2 wherein the wire turns in the same direction being systematically separated from one another by a segment Si+1 wherein the wire turns in the opposite direction, and
the aggregate of the numbers Ni of each segment Si of the abrasive wire being less than or equal to Max [(|Ni|+|Ni+1|)/4], where:
“Max” is the function which returns the maximum for any i variant from 1 to Np of the sum (|Ni|+|Ni+1|)/4, and
“| . . . |” is the absolute value function.

11. The roll as claimed in claim 10, wherein the length of each segment Si lies between 1 m and 100 m.

12. A machine for cutting slices from an ingot made of hard material, said machine comprising two wire guides capable of guiding the displacement of an abrasive wire, in accordance with claim 4, by making it rub on the ingot and thus saw said ingot,
wherein:
an electronic sensor sensitive to the reflectance of the cylindrical outer face of the abrasive wire at least at the wavelength λm, and
a processing unit suitable for:
computing, in the displacement of the wire between the two wire guides and from the measurements of the electronic sensor sensitive to the reflectance, at least one characteristic of the current shape of a mark present on the outer face of the abrasive wire, the characteristic of said mark varying as a function of the twisting of the abrasive wire, and
estimating the twisting of the abrasive wire from the computed characteristic of the current shape of the mark and from a known value of said characteristic corresponding to a known twisting of the abrasive wire.
